(19) United States
(12) Patent Application Publication
(10) Pub. No.: US 2018/0346139 A1
(43) Pub. Date: Dec. 6, 2018

(54) METHOD OF MANAGEMENT AND ARCHITECTURE OF A HYBRID PROPULSION SYSTEM

(71) Applicant: Airbus SAS, Blagnac (FR)

(72) Inventors: Benoit FERRAN, PARIS (FR); Emmanuel JOUBERT, ISSY-LES-MOULINEAUX (FR); Nicolas Fouquet, VELIZY VILLACOUBLAY (FR); Jonathan LANDOLT, Toulouse (FR)

(21) Appl. No.: 15/984,638

(22) Filed: May 21, 2018

(30) Foreign Application Priority Data
Jun. 6, 2017 (FR) 1755027

(51) Int. Cl. B64D 31/06; B64D 27/24; G10K 15/00

(52) U.S. Cl. CPC B64D 31/06; B64D 2027/026; G10K 15/00; B64D 27/24

(57) ABSTRACT

A method and an architecture for implementing the method for the management of a hybrid thermal/electrical propulsion aircraft in the course of its various flight phases. The hybrid propulsion receives at each instant i a total power command Ptot,com,i distributed between thermal Pth,com,i and electrical Pe,com,i power commands. The method includes steps of calculating a maximum admissible thermal power command Pth,com,max,i for compliance with acoustic objectives on the ground, selecting the thermal power command Pth,com,i in a bounded range of values, determining the electrical power command Pe,com,i. The thermal Pth,com,i and electrical Pe,com,i power commands supplied by the hybrid propulsion are thus adjusted in the course of the different flight phases depending on a height hi of the aircraft in order to make it possible to comply with acoustic requirements on the ground.

### CROSS-REFERENCES TO RELATED APPLICATIONS

This application claims the benefit of the French patent application No. 1755027 filed on Jun. 6, 2017, the entire disclosures of which are incorporated herein by way of reference.

### TECHNICAL FIELD

The invention belongs to the field of hybrid propulsion vehicles.

More particularly, the invention belongs to the field of hybrid propulsion aircraft.

### BACKGROUND OF THE INVENTION

Traditionally, reducing the noise from aircraft thermal engines during low altitude flight phases (take-off, initial climb, approach, landing) in the field of aviation is performed by treating the sound sources in order to limit radiation.

For example, the European patent EP 2932051 describes acoustic panels intended to be fixed inside a fan casing of a turbojet engine. U.S. patent application US 2015/0367953 describes an acoustic liner for a turbofan.

This type of complex acoustic liner represents a substantial onboard mass not necessary in high altitude flight phases (end of climb, cruise, initial descent), for which acoustic radiation is no longer problematic.

The development of aircraft with mixed thermal/electrical propulsion has led to a strategy of hybridization using the propulsion modes according to the flight phases depending on the level of radiated noise: electrical propulsion for low altitude flight phases and thermal propulsion for high altitude flight phases. The electrical propulsion mode is switched over to the thermal propulsion mode when the sound footprint on the ground with thermal propulsion is acceptable.

One drawback of this strategy of hybridization is that it requires a battery system having a considerable onboard mass in order to be able to supply the electrical energy necessary to the take-off and low altitude flight phases, which affects the performance of the aircraft.

Furthermore, the battery system supplying such propulsion must be dimensioned according to the requirements of take-off and therefore be composed of high power density batteries, so as to deliver high power at medium, or even low, voltages, involving a high discharge current, which reduces their storage performance. Accordingly, the energy density of the onboard batteries is less, their autonomy reduced, and the onboard mass of the battery system is unfavorable.

### SUMMARY OF THE INVENTION

The invention provides a solution to the unresolved problems of the prior art and makes it possible to benefit from thermal propulsion performance over all the flight phases in compliance with the acoustic requirements on the ground.

The invention relates to a method for the management of a hybrid thermal/electrical propulsion of an aircraft intended to receive at each instant i a total power command Ptot,com,i of the aircraft, the hybrid propulsion comprising a thermal propulsion path and an electrical propulsion path intended to respectively receive a thermal power command Pth,com,i and an electrical power command Pe,com,i a sum of which is equal to the total power Ptot,com,i received by the hybrid propulsion. According to the invention, the method comprises:
a step of calculating a maximum admissible thermal power command Pth,com,max,i, defined as the greatest thermal power command Pth,com,i, in a range of values [0; Ptot,com,i], for obtaining a maximum acoustic footprint on the ground of the aerodynamic noise of the aircraft compatible with a requirement of admissible sound level on the ground;
a step of selecting the thermal power command Pth,com,i such that it is included within the range of values [0; Pth,com,max,i], the thermal power command Pth,com,i being equal to a percentage of thermal power Pth %,i of the maximum thermal power command Pth,com,max,i;
a step of determining the electrical power command Pe,com,i such that:

Pe,com,i=Ptot,com,i−Pth,com,i

In one implementation, the percentage of thermal power Pth %,i is adjusted at each instant i according to the evolution of the profile of the maximum thermal power command Pth,com,max,i calculated in the step of calculating.

In one implementation, the percentage of thermal power Pth %,i is adjusted at each instant i according to a state of ageing of a battery system of the electrical propulsion path.

In one implementation, the percentage of thermal power Pth %,i is adjusted at each instant i according to a fuel level of the thermal propulsion path (130).

In one implementation the percentage of thermal power Pth %,i is substantially equal to 100% at each instant i.

The invention also relates to an architecture of a hybrid propulsion aircraft for implementing the method according to the invention. The architecture according to the invention comprises:

an overall pilot power control of a hybrid thermal/electrical propulsion;

a thermal propulsion path of the hybrid propulsion, including a thermal internal combustion engine;

an electrical propulsion path of the hybrid propulsion, including an electric motor;

a propulsion member.

According to the invention, the architecture comprises a management device of the hybrid propulsion configured for:

calculating a maximum admissible thermal power command Pth,com,max,i according to predefined acoustic constraints on the ground;

selecting the thermal power command Pth,com,i to be transmitted to the thermal propulsion path;

determining the electrical power command Pe,com,i to be transmitted to the electrical propulsion path.

In one embodiment, the architecture further comprises a power management system capable of interpreting information from the pilot power control for separately controlling the thermal propulsion path and the electrical propulsion path, so as to allow an adjustment of the thermal Pth,com,i and electrical Pe,com,i power commands delivered by the thermal and electrical propulsion paths of the hybrid propulsion, the power management system further including calculating means notably incorporating:

a map of the ground for performing calculations on a lattice of this ground;

an acoustic model of the aircraft incorporating a set of acoustic features such as directivity diagrams of aerodynamic or engine acoustic sources;

acoustic objectives.

### BRIEF DESCRIPTION OF THE DRAWINGS

The invention will be better understood on reading the following description and studying the figures that accompany it. These are given only by way of a non-restrictive illustration of the invention.

FIG. 1 represents a schematic diagram of the distribution of the total, thermal and electrical powers according to the method of the invention.

FIG. 2 represents the main steps of the method according to the invention.

FIG. 3 represents the evolution profiles of the thermal power command in the course of the aircraft's climb in three implementations of the method according to the invention.

FIG. 4 illustrates an example of evolutions of the thermal and electrical power commands during take-off, initial climb, end of climb and cruise phases.

FIG. 5 represents a diagram of a series hybrid architecture of an aircraft according to an embodiment of the invention.

FIG. 6 represents a diagram of a parallel hybrid architecture of an aircraft according to an embodiment of the invention.

### DETAILED DESCRIPTION OF THE PREFERRED EMBODIMENTS

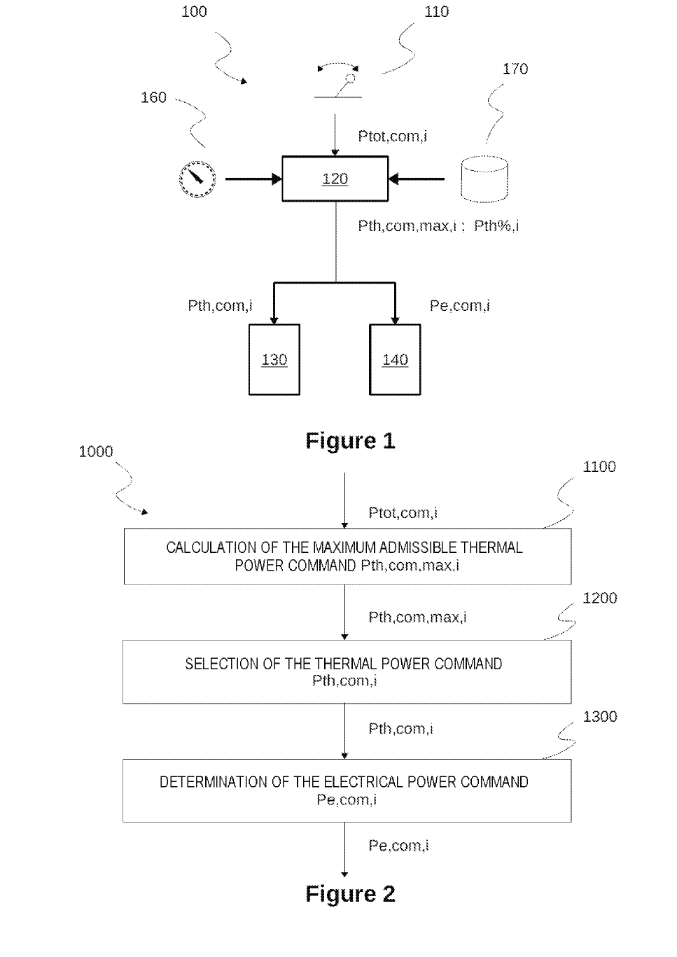

With reference to FIGS. 1 and 2, a method 1000 according to the invention makes it possible to manage a hybrid propulsion chain of an aircraft during all of its flight phases: take-off, initial climb, end of climb, cruise, initial descent, approach, landing. It is an iterative method which is continuously implemented during all the flight phases.

“Continuously” is understood to mean that the implementation time of an iteration of the method and a time interval between two iterations of the method are sufficiently small for the implementation of the method to be able to be perceived by any system and or operator capable of interacting with the hybrid propulsion chain as being continuous.

The hybrid propulsion of the aircraft comprises:
a thermal propulsion path 130;
an electrical propulsion path 140.

In the rest of the description, it is assumed that electrical propulsion is less noisy than thermal propulsion for similar powers, which is generally observed.

At a given height h, a total power Ptot,h delivered by the hybrid propulsion is equal to the sum of a thermal power Pth,h delivered by the thermal propulsion path 130 and an electrical power Pe,h delivered by the electrical propulsion path 140:

P_{tot,h}=P_{th,h}+P_{e,h} (1)

With reference to FIG. 1, at an instant i, the hybrid propulsion receives a total power command Ptot,com,i to be delivered, which total power command Ptot,com,i is dependent on the height hi of the aircraft at the instant i and on the flight phase of the aircraft considered. The total power command Ptot,com,i is then distributed between a thermal power command Pth,com,i and an electrical power command Pe,com,i intended to be received respectively by the thermal propulsion path 130 and the electrical propulsion path 140, so that a noise level Lavion,i on the ground attributable to the aircraft at the instant i complies with a sound level objective Lref,i, e.g. for complying with the requirements established by the Civil Aviation Directorate or the International Civil Aviation Organization.

According to the invention, the total power command Ptot,com,i is distributed between the thermal 130 and electrical 140 propulsion paths so that there is a gradual transition between a low altitude propulsion mode favoring less noisy electrical propulsion and a high-altitude propulsion mode favoring noisier thermal propulsion. In the course of this transition, the thermal Pth,com,i and electrical Pe,com,i power commands are in general substantially not zero and are made to evolve. In this way, the propulsion benefits in an optimum manner from the power provided by thermal propulsion, and the power supplied by electrical energy generation 141, e.g., accumulators, is less than for entirely electrical propulsion, and therefore the energy required also, which ultimately allows a resizing of the electrical energy generation and a minimization of the mass of the onboard battery system.

With reference to FIG. 2, in a first step of the method 1000 according to the invention, the maximum admissible thermal power command Pth,com,max,i at the instant i for compliance with the acoustic objectives on the ground, is calculated 1100. It is determined as the greatest thermal power Pth,com,i verifying, for the height hi of the aircraft and for any point M of the ground in an acoustic environment of the aircraft, the conditions below:

$$\{ \begin{matrix}{L}_{ref , i} ( M ) - {L}_{avion , i} ( {P}_{tot , com , i} - {P}_{th , com , i} ; {P}_{th , com , i} ; ϕ , M ) \geq 0 \\ {P}_{th , com , i} \leq {P}_{tot , com , i}\end{matrix} \qquad ( 2 )$$

where:
Lavion,i(a,b,φ,M) is the sound level attributable to the aircraft, at the instant i, according to:

its electrical power a;

its thermal power b;

the position parameters of the aircraft φ and parameters of an environment of the aircraft (attitude, height, ambient temperature, etc.);

the point M considered.

“Acoustic environment of the aircraft” is understood to mean a set of parameters influencing the propagation of the sound waves emitted by the various sound sources of the aircraft (propeller, engines and other aerodynamic sources), e.g., ambient temperature of the air, relief of the ground, etc.

The noise level Lavion,i is calculated with the aid of an acoustic model of the aircraft and its environment and notably incorporates flight parameters 160 (position parameters of the aircraft, for example) and acoustic data 170 (directivity diagrams of the sound sources, for example). Depending on the complexity of the acoustic model adopted, the number of parameters taken into account in the modelling may vary and may incorporate, for example:

attitude of the aircraft;

ambient temperature;

ambient pressure;

directivity diagram of the engines;

etc.

Subsequently, the thermal Pth,com,i and electrical Pe,com,i power commands to be delivered are respectively selected 1200 and determined 1300 taking into account the maximum value Pth,com,max,i of the thermal power command Pth,com,i determined in the preceding step 1100 and the condition of Equation (1), so that the thermal Pth,com,i and electrical Pe,com,i power commands belong respectively to value ranges [0; Pth,com,max,i] and [Pe,com,min,i; Ptot,com,i] where Pe,com,min,i designates a minimum electrical power command, complementary to the maximum thermal power command Pth,com,max,i for compliance with acoustic requirements, i.e.:

P_{tot,com,i}=P_{th,com,max,i}+P_{e,com,min,i}

Thus, during the step of selecting the thermal power command 1200, a percentage of thermal power Pth %,i of the maximum thermal power Pth,com,max,i, is adopted calculated in the preceding step 1100:

P_{th,com,i}=P_{th %,i}P_{th,com,max,i} (4)

During the step of determining the electrical power command 1300, the electrical power command Pe,com,i is determined by the relationship:

P_{tot,com,i}=P_{th,com,i}+P_{e,com,i} (5)

In one implementation, the percentage of thermal power Pth %,i is equal at each instant i to 100% of the maximum thermal power command Pth,com,max,i calculated 1100. This strategy makes it possible to benefit in an optimum manner from the performance of the thermal engine while complying with the acoustic requirements on the ground.

However, although the maximum admissible thermal power command Pth,com,max,i is increasing (decreasing respectively) overall in the course of the climb (respectively the descent) due to the overall gain (respectively loss) in height of the aircraft, it may be that the evolution of the command undergoes local variations in monotony, hereafter known as “parasite variations.” This phenomenon may, for example, occur when the aircraft has to take off or land in the vicinity of mountains or hills, since the evolution of the profile of the ground in the environment of the aircraft in these conditions may create height differentials locally contrary to its overall evolution or to varying requirements because of a particular ground environment. In this kind of situation, a percentage of thermal power Pth %,i of 100% requires adjusting accordingly the thermal power command Pth,com,i at each instant i in order to keep complying with the acoustic requirements.

For avoiding such adjustments, in an alternative implementation, the percentage of thermal power Pth %,i evolves in the following manner:
it is set by default to a default percentage of thermal power Pth %,d strictly less than 100%, e.g. 70%;
it remains set at this value as long as parasite variations are not observed in the maximum admissible thermal power command Pth,com,max,i;
as soon as such parasite variations are observed, the percentage of thermal power Pth %,i is adjusted so that the thermal power command Pth,com,i remains equal during these parasite variations to the value of the thermal power command Pth,com,i determined before the start of the parasite variations. Once these parasite variations have disappeared, the percentage of thermal power Pth %,i is redefined as being equal to the default value Pth %,d.

It may be considered, for example, that the parasite variations have disappeared after an absence of variation in the monotony of the curve of the maximum admissible thermal power command Pth,com,max,i over a predefined duration.

In one implementation, the choice of the initial percentage of thermal power Pth %,d depends on the risk of occurrence of parasite variations and their amplitude, therefore on the environment of the aircraft during low altitude flight phases. It is advantageously small enough for being able to absorb the predictable parasite variations, i.e. to make it possible a priori to preserve a constant value throughout the duration of the parasite variations.

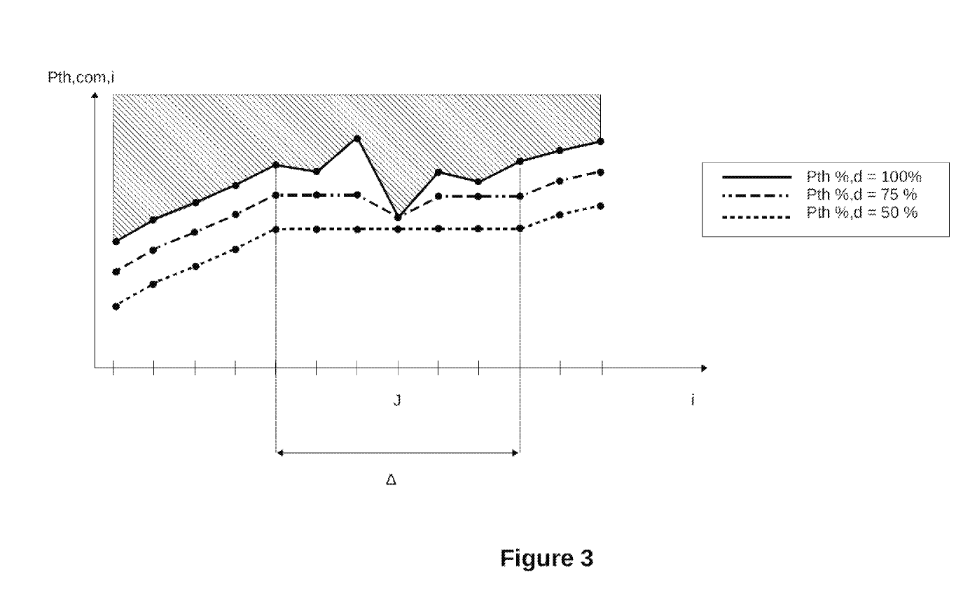

By way of example, reference is made to FIG. 3 illustrating an evolution profile of the thermal power command Pth,com,i as a function of time in the course of a climb phase.

The curve in a continuous line illustrates the maximum admissible thermal power command Pth,com,max,i calculated in step 1100, as a function of the sampled time, symbolized by a dot. This continuous curve is equivalent to the thermal power command Pth,com,i selected in step 1200 for a strategy of hybridization according to which the percentage of thermal power Pth %,i is equal at any instant to 100%. The hatched area therefore corresponds to the prohibited thermal power command values Pth,com,i.

Over an area Δ parasite variations are observed of the maximum thermal power command Pth,com,max,i. Three implementations of the method are illustrated:

In a first implementation, the default percentage of thermal power Pth %,d is set at 100%, and the percentage of thermal power Pth %,i is never readjusted and remains equal to the default percentage. The thermal power command Pth,com,i (in a continuous line) then undergoes the same variations as the maximum thermal power command Pth,com,max,i.

In a second implementation, the default percentage of thermal power Pth %,d is set at 50%, but the percentage of thermal power Pth %,i may be readjusted according to the evolution of the maximum thermal power command Pth,com,max,i. In this implementation, as soon as the parasite variations are identified, the value of the thermal power command Pth,com,i is set at a constant value equal, for example, to the value that it had in the preceding iteration. In this implementation, the percentage of thermal power Pth %,i is therefore readjusted during the parasite variations so that the thermal power command Pth,com,i (in a broken line) remains constant and does not undergo the variations in the maximum thermal power command Pth,com,max,i.

In a third implementation, the default percentage of thermal power Pth %,d is set at 75%, but the percentage of thermal power Pth %,i may be readjusted according to the evolution of the maximum thermal power command Pth,com,max,i. This implementation is similar to the second implementation, except that the amplitude of the parasite variations is such that the thermal power command Pth,com,i cannot remain constant during the parasite variations, without the acoustic objectives on the ground no longer being complied with at the instant J. At the instant J, the percentage of thermal power Pth %,J is therefore brought back to 100%, for complying with the acoustic objectives while minimizing the variation in the thermal power command. In this implementation, the thermal power command Pth,com,i (in a mixed line) only very slightly undergoes the variations in the maximum thermal power command Pth,com,max,i.

In an alternative implementation, the percentage of thermal power Pth %,i may also be adjusted for taking account of the autonomy of each of the thermal 130 and electrical 140 propulsion paths.

By way of example, in the case of a low autonomy battery or one exhibiting a state of advanced ageing, the percentage of thermal power Pth %,i may be high in order to favor thermal propulsion, e.g., equal to 90%.

Similarly, in cases of emergency or situations in which a fuel of the thermal propulsion path must be consumed sparingly, e.g., in the case of the aircraft being in a holding pattern or diverted, the percentage of thermal power Pth %,i may be low in order to favor electrical propulsion, e.g., equal to 20%.

Advantageously, the batteries are recharged in the course of the flight phases during which the electrical propulsion path is substantially inactive.

By way of example, the method of the invention is detailed for each of the flight phases of the aircraft in a particular implementation.

During the take-off phase, the thermal power command Pth,com,i is equal to an initial value Pth,com,0 and the electrical power command Pth,com,i is equal to an initial value Pe,com,0.

In the course of the initial climb, i.e., between a height zero and a first limit height h1, the thermal power command Pth,com,i increases overall with the height hi, the thermal power command being able to decrease locally in case of parasite variations, as seen earlier. The percentage of thermal power Pth %,i is, for example, equal to 100%. The electrical power command Pe,com,i decreases with the height hi, so that Equation (5) is respected.

When the aircraft reaches the first limit height h1, the electrical power command Pe,com,i becomes substantially zero, the propulsion becomes entirely thermal and remains so during the end of the climb and the cruise. From this limit height h1, the thermal power command Pth,com,i is substantially equal to the total power command Ptot,com,i.

By way of example, for a hybrid propulsion aircraft the maximum take-off mass of which is 3 000 kg, the limit height h1 is approximately 2 000 feet (approximately 600 meters).

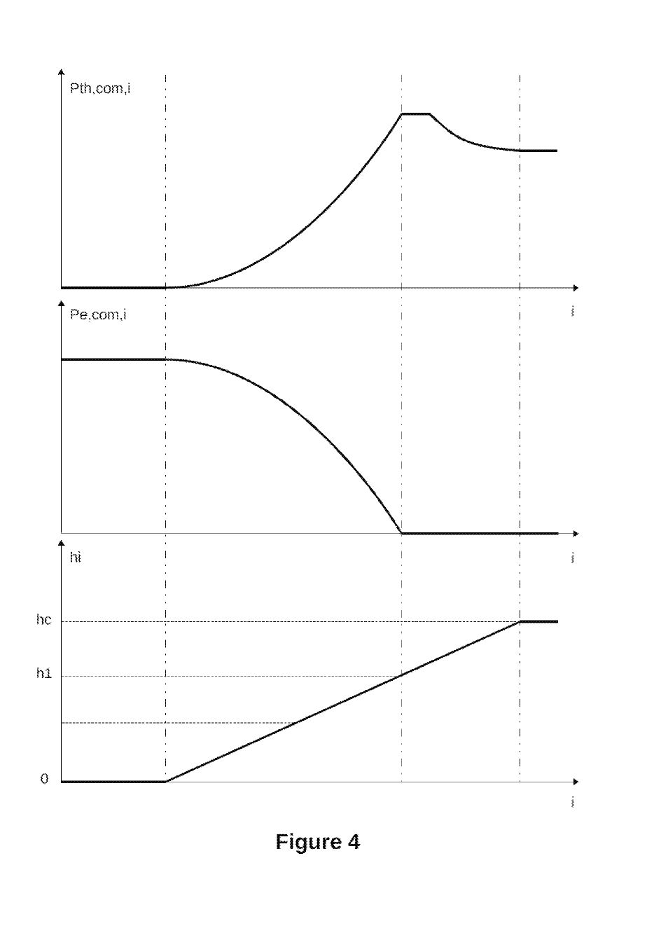

Examples of evolution profiles of the thermal Pth,com,i and electrical Pe,com,i power commands in the course of the take-off, initial climb and end of climb phases are given in FIG. 4.

Preferably, the batteries are recharged during the cruise phase.

The propulsion is entirely thermal during the initial descent phase, which takes place between a cruise height hc and a second limit height h2 from which the acoustic requirements on the ground are no longer respected.

In the course of the approach phase taking place between the second limit height h2 and landing, the thermal Pth,com,i and electrical Pe,com,i power commands are adjusted according to the method 1000 of the invention in a manner similar to the approach described for the initial climb. During the approach phase, the thermal power command Pth,com,i decreases overall while the electrical power command Pe,com,i increases overall.

According to the solutions of the prior art described above, the total power command Ptot,com,i follows a binary logic:

in the course of low altitude flight phases, the electrical power command Pe,com,i is substantially equal to the total power command Ptot,com,i and the thermal power command Pth,com,i is substantially zero, in order to limit the acoustic radiation of the propulsion;

in the course of high altitude flight phases, the thermal power command Pth,com,i is substantially equal to the total power command Ptot,com,i and the electrical power command Pe,com,i is substantially zero, in order to benefit from the performance of the thermal propulsion and allow the batteries to recharge.

Compared to the currently existing hybrid solutions for which the thermal and electrical propulsion paths are not substantially active simultaneously during the flight phases of the aircraft, the method according to the invention makes it possible to decrease the power supplied by the batteries during flight, as well as the electrical energy required.

Furthermore, during the initial climb phase, the electrical power command required decreases with altitude. Accordingly, thanks to this drop in electrical power required, it is not necessary, for compensating for the drop in voltage at the terminals of the batteries in the course of the climb, to increase the current delivered by the batteries as greatly as for a hybridization operating entirely thanks to an electrical propulsion on this same climb phase. This makes it possible to use batteries having a greater autonomy, which also facilitates their thermal conditioning thanks to the reduction in the Joule effect.

All of these elements make it possible to advantageously reduce the mass of the onboard batteries in the aircraft.

With reference to FIGS. 1, 5 and 6, the invention also relates to an architecture 100 of a hybrid propulsion system for implementing the method described above.

In the embodiment described below, the architecture 100 according to the invention comprises:

a pilot power control 110;

a power management system 120;

a thermal propulsion path 130 of the hybrid propulsion, notably including a fuel tank 131 supplying a thermal internal combustion engine MT;

an electrical propulsion path 140 of the hybrid propulsion, notably including at least one battery 141 supplying a motor control unit 142 controlling an electric motor ME;

a propulsion member 150, e.g., a propeller.

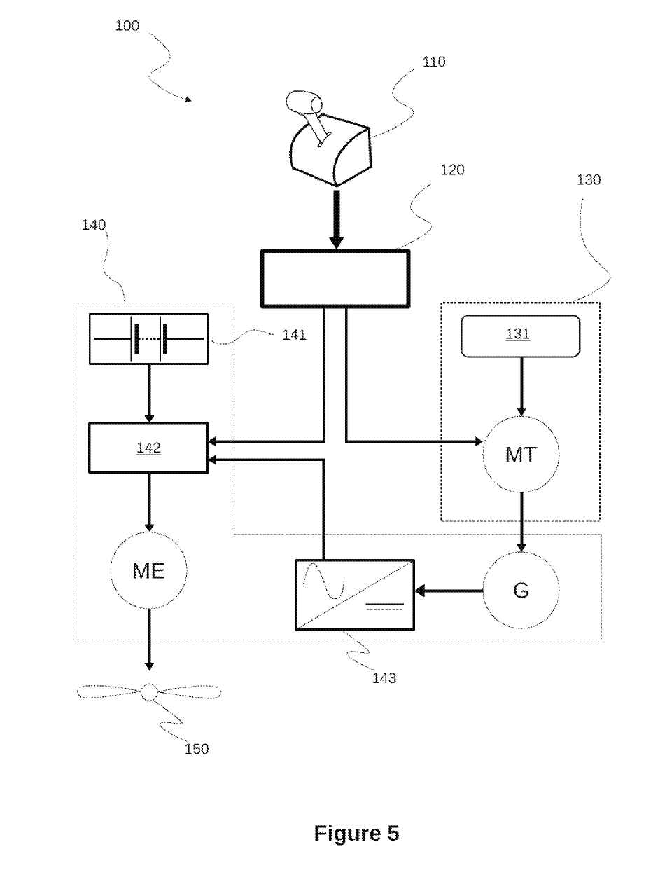

FIG. 5 represents a series hybrid architecture in which a propeller 150 is driven by the electric motor ME. In this architecture, the electrical propulsion path 140 also comprises a generator G powered by the thermal engine MT, as well as a rectifier 143.

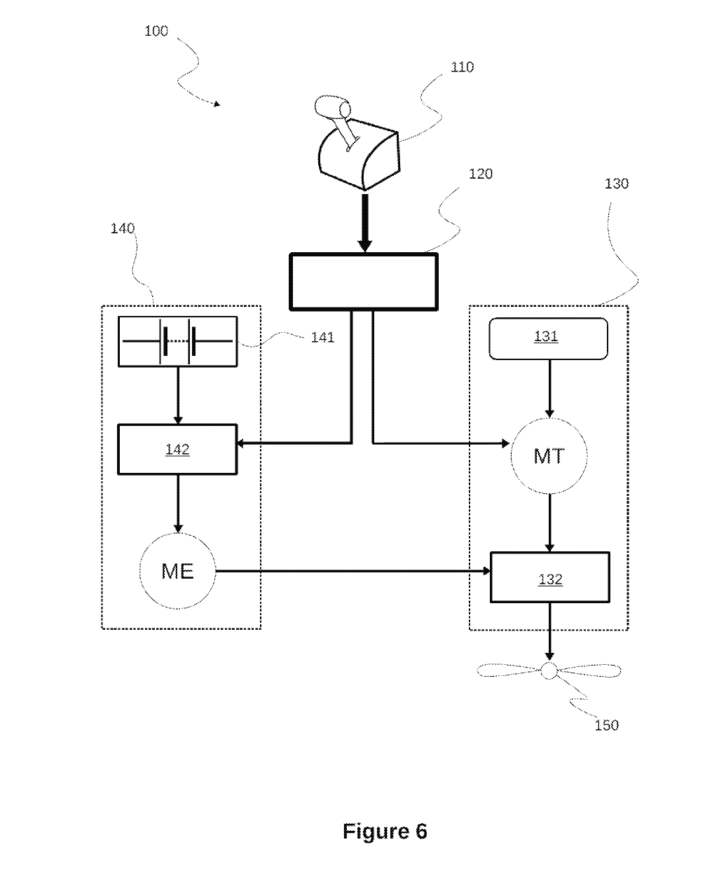

FIG. 6 represents such a hybrid architecture in parallel in which the propeller 150 is driven, according to the flight conditions, by the electric motor ME and or the thermal engine MT. In this type of architecture, the thermal propulsion path 130 also comprises a mechanical coupling 132 of the power shafts of the electric motor ME and the thermal engine MT.

The pilot control 110 transmits to the power management system 120 the total power command Ptot,com,i required and adjusted manually by a pilot or by an automatic pilot in the course of the flight and according to the flight phases.

The management system 120 makes it possible to distribute the total power command Ptot,com,i between the thermal 130 and electrical 140 propulsion paths, according to the method described above. The management system 120 communicates with the thermal engine MT of the thermal propulsion path 130 and the motor control unit 142 of the electrical propulsion path, to which the power instructions are transmitted.

The management system 120 comprises computers for calculating noise levels Lavion,i on the ground attributable to the aircraft. For performing this calculation, the management system 120 incorporates a database notably comprising:
a map of the ground for performing the calculations on a lattice of this ground, e.g., at 1 meter above the ground;
an acoustic model of the aircraft incorporating a set of acoustic features such as directivity diagrams of the aerodynamic or engine acoustic sources, e.g., directivity diagrams of the propeller 150;
acoustic requirements to take into consideration by default or for a particular area.

The power management system 120 determines the pair of powers (Pe,com,min,i; Pth,com,max,i) according to the method of the invention. It also comprises means of distributing power for distributing the determined power commands over the thermal 130 and electrical 140 propulsion paths.

In the embodiment described in FIG. 1, the management system may take flight parameters 160 (attitude, height, etc.) and/or the acoustic data 170 (ambient temperature of the air, directivity diagram of the sound sources, etc.) as input.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for the management of a hybrid thermal/electrical propulsion of an aircraft intended to receive at each instant i a total power command Ptot,com,i of the aircraft, said hybrid propulsion comprising a thermal propulsion path and an electrical propulsion path intended to respectively receive a thermal power command Pth,com,i and an electrical power command Pe,com,i a sum of which is equal to a total power Ptot,com,i received by said hybrid propulsion, said method comprising:
calculating a maximum admissible thermal power command Pth,com,max,i, defined as a greatest thermal power command Pth,com,i, in a range of values [0; Ptot,com,i], for obtaining a maximum acoustic footprint on the ground of an aerodynamic noise of the aircraft compatible with a requirement of admissible sound level on the ground;
selecting the thermal power command Pth,com,i such that it is included within the range of values [0; Pth,com,max,i], said thermal power command Pth,com,i being equal to a percentage of thermal power Pth %,i of the maximum thermal power command Pth,com,max,i;
determining an electrical power command Pe,com,i such that:
Pe,com,i=Ptot,com,i−Pth,com,i

2. The method according to claim 1, wherein the percentage of thermal power Pth %,i is adjusted at each instant i according to an evolution of a profile of the maximum thermal power command Pth,com,max,i calculated in the step of calculating.

3. The method according to claim 1, wherein the percentage of thermal power Pth %,i is adjusted at each instant i according to a state of ageing of a battery system of the electrical propulsion path.

4. The method according to claim 1, wherein the percentage of thermal power Pth %,i is adjusted at each instant i according to a fuel level of the thermal propulsion path.

5. The method according to claim 1, wherein the percentage of thermal power Pth %,i is substantially equal to 100% at each instant i.

6. An architecture of a hybrid propulsion aircraft for implementing a method according to claim 1, comprising:
an overall pilot power control of a hybrid thermal/electrical propulsion;
a thermal propulsion path of the hybrid propulsion, including a thermal internal combustion engine;
an electrical propulsion path of the hybrid propulsion, including an electric motor;
a propulsion member;
a management device of the hybrid propulsion configured for:
calculating a maximum admissible thermal power command Pth,com,max,i according to predefined acoustic constraints on the ground;
selecting the thermal power command Pth,com,i to be transmitted to the thermal propulsion path;
determining the electrical power command Pe,com,i to be transmitted to the electrical propulsion path.

7. The architecture according to claim 6, further comprising a power management system capable of interpreting information from the pilot power control for separately controlling the thermal propulsion path and the electrical propulsion path, so as to allow an adjustment of the thermal Pth,com,i and electrical Pe,com,i power commands delivered by said thermal and electrical propulsion paths of the hybrid propulsion, said power management system further including calculating means incorporating:
a map of the ground for performing calculations on a lattice of this ground;
an acoustic model of the aircraft incorporating a set of acoustic features;
acoustic objectives.

8. The architecture according to claim 7, wherein the acoustic features incorporated in the acoustic model include such as directivity diagrams of aerodynamic acoustic sources.

9. The architecture according to claim 7, wherein the acoustic features incorporated in the acoustic model include such as directivity diagrams of engine acoustic sources.
